(19) United States
(12) Patent Application Publication
(10) Pub. No.: US 2013/0185226 A1
(43) Pub. Date: Jul. 18, 2013

(54) METHOD OF, AND SYSTEM FOR, ASSET INDEX GENERATION WITH SELF FINANCING PORTFOLIO ADJUSTMENT

(71) Applicant: ARES Capital Management Pty Ltd, Syndey (AU)

(72) Inventors: Matthew Bryce Hardman, Sydney (AU); Alun Lloyd Pope, Belair (AU)

(73) Assignee: ARES Capital Management Pty Ltd, Syndey (AU)

(21) Appl. No.: 13/715,094

(22) Filed: Dec. 14, 2012

(30) Foreign Application Priority Data
Dec. 15, 2011 (AU) 2011 905 231

(51) Int. Cl. G06Q 40/06

(52) U.S. Cl. CPC G06Q 40/06
USPC 705/36 R

(57) ABSTRACT

Asset indexes are intended to track changes in the market value of assets. However, some assets such as real estate can change in value for reasons other than that a general change in the market has occurred. For example, a house can have an addition which adds another bedroom or a portion of land can be sub-divided, in which case an increase or decrease respectively in the asset value can occur which is independent of movements in the overall market. A method of generating an asset index under these circumstances is disclosed by effectively removing from the asset portfolio those assets which have had a change in attribute come to notice on the day the asset index is calculated. Such an asset is restored to the portfolio on subsequent days.

The present invention relates to computer generated digitally encoded electric waveforms and their use in the implementation of financial methods and systems. In the preferred embodiment of the invention to be described hereafter, the description is primarily concerned with the calculation of daily indices in relation to residential property, however, the invention is not restricted to this asset class and is applicable to other types of assets such as motor vehicles.

### COPYRIGHT NOTICE

This patent specification contains material which is subject to copyright protection. The copyright owner has no objection to the reproduction of this patent specification or related materials from associated patent office files for the purposes of review, but otherwise reserves all copyright whatsoever.

### TECHNICAL FIELD OF THE INVENTION

The present invention relates to computer generated digitally encoded electric waveforms and their use in the implementation of financial methods and systems. In the preferred embodiment of the invention to be described hereafter, the description is primarily concerned with the calculation of daily indices in relation to residential property, however, the invention is not restricted to this asset class and is applicable to other types of assets such as motor vehicles.

### BACKGROUND ART

Most individuals own assets which may be conveniently categorised into three classes. The first class is fixed physical assets such as real estate, predominantly the residential home of the individual. The second class is moveable physical assets, such as motor vehicles or other items of equipment. The third class of assets are financial assets such as shares in listed companies, bonds and the like.

It is useful to know how the values of such assets change over time. In relation to the abovementioned financial assets such as listed company shares and bonds, there is a wealth of financial data. In addition to historical data there is also provided what might be termed “synthetic products” such as a stock exchange index which tracks the overall price movement of the exchange. In Australia such an index is known as the ASX, the USA has the Dow Jones and the Standard & Poors, Britain has the Financial Times Index (or “Footsie”), and so on. In addition to price (or capital gain/loss) indices, there are also accumulation indices which indicate the total returns taking into account both capital gains (or losses) and revenue received by way of dividends. In addition there is a raft of financial products available including options, derivatives and the like which are tailored towards various persons and corporations which have specific needs or uses for such financial instruments.

However, in respect of non-financial assets there are few equivalents available. For example, in relation to motor vehicles, whilst there is data as to new vehicle prices and also data as to the price of used vehicles as to age, it is not immediately apparent from any of these price indications as to whether or not the rate of depreciation of motor vehicles is changing, for example. Such information would be of interest to corporations having fleets of motor vehicles, and even to an individual contemplating making a decision as to whether to retain an existing vehicle, to sell the existing vehicle and purchase a new vehicle, or to sell the existing vehicle and purchase a used vehicle. A similar comment applies in relation to fixed assets such as real estate.

The genesis of the present invention is a desire to at least ameliorate the abovementioned situation by the provision of, or generation of, asset indices.

The generation of asset indices in the modern world requires the use of computers. Whilst it is theoretically possible to manually generate an asset index (over a short period of time at least) using “paper and pencil” or paper and calculator” methods, in practice the volume of data is overwhelming and so modern computers must be utilised. This transforms the problems involved in the creation of such an asset index into the realm of electrical engineering. It is the solution of the electrical engineering problems inherent in the generation of an asset index that is the subject of the present invention.

The present applicant has filed an International Patent Application No. PCT/AU2008/000244 (published under No. WO 2008/104018) (Attorney Ref 5097I-WO), which corresponds to U.S. application Ser. No. 12/527,832, and Australian Patent Application No. 2010 201 821 (Attorney Ref 5097L-AU), all of which disclose, amongst other things, the generation of a real estate index. In the preferred embodiment of the present invention, the methods disclosed in the above-mentioned patent specifications are, or can be, utilised. Accordingly, the disclosures of all of the abovementioned patent applications is hereby incorporated by the present specification for all purposes.

The present invention is particularly concerned with overcoming various difficulties in the production of such indices brought about by changes of a capital nature such as expenditure on additions to housing, rather than changes in the actual market price of such housing.

### SUMMARY OF THE INVENTION

In accordance with a first aspect of the present invention there is disclosed a method of calculating an index of price movements of a class of assets, which index is substantially independent of price movements of a capital nature, said method comprising the steps of:

(i) storing historical time of sale data, historical price data and historical asset characterisation data regarding previous asset sales of assets in said class of assets,
(ii) inputting a tranche of current data regarding current sales of assets in said class of assets, said current data including current price data and current asset characterisation data,
(iii) comparing said current asset characterisation data with said historical asset characterisation data to identify specific assets which have been sold previously and re-sold currently,
(iv) comparing the asset characterisation data of said specific assets to determine those specific assets, if any, which have undergone a change of a capital nature between said previous sale and said current re-sale, and
(v) excluding said capital change specific assets from said index generation.

In accordance with a second aspect of the present invention there is disclosed a method of generating a digitally encoded electric signal to represent an index of price movements of a class of assets, which index is substantially independent of price movements of a capital nature, said method comprising the steps of:

(i) storing in a data storage means historical time of sale data, historical price data and historical asset characterisation data regarding previous asset sales of assets in said class of assets,
(ii) inputting into said data storage means a tranche of current data regarding current sales of assets in said class of assets, said current data including current price data and current asset characterisation data,
(iii) comparing, in a comparator means connected with said data storage means, said current asset characterisation data with said historical asset characterisation data to identify specific assets which have been sold previously and re-sold currently,
(iv) comparing in said comparator means the asset characterisation data of said specific assets to determine those specific assets, if any, which have undergone a change of a capital nature between said previous sale and said current re-sale,
(v) computing said index whilst excluding said capital change specific assets from said computation, and
(vi) outputting said digitally encoded electric signal to represent said index.

Preferably the index is calculated on each occasion of a successive sequence of occasions, and said excluding step (v) comprises:

(vi) excluding the capital change specific assets from a portfolio assets used in the current index calculation to calculate a current portfolio value,
(vii) re-calculating the value of the same portfolio of assets on the occasion immediately preceding the current occasion,
(viii) summing the current portfolio values, summing the immediately preceding portfolio values and dividing the sum of the current portfolio values by the sum of the immediately preceding portfolio values to create the index increment for the current index calculation.

### BRIEF DESCRIPTION OF THE DRAWINGS

A preferred embodiment of the present invention will now be described with reference to the accompanying drawings in which:

FIG. 1 is a flow chart illustrating the production of a capital gains index,

FIG. 2 is a similar flow chart illustrating the production of an accumulation index,

FIG. 3 is a similar flow chart illustrating the initial production of a self-financing index,

FIGS. 4A and 4B are a two page flow chart illustrating the production of a self-financing index on a subsequent date,

FIG. 5 is a similar flow chart illustrating the production of a self-financing index including rental data,

FIG. 6 is a block diagram of a computer system on which embodiments of the present invention can be implemented, and

FIG. 7 is a representation of a digitally encoded electric waveform.

### DETAILED DESCRIPTION

In the preferred embodiment, the following problem is addressed. A particular city, or collection of cities, has a stock of housing (which can be freestanding houses, apartments (or units or condominiums) or the like) which is continually being modified by their owners so that the housing is upgraded, for example by the addition of an ensuite bathroom, by the addition of one or more extra bedrooms, and so on. These additions represent the input of additional capital by the owners and result in the value of the property being increased. This change in the structure of the house comes to public notice when the house is sold, or if the house is offered for rent.

For example, if the house is sold, then the value of the house has changed (in general increased) from its last sale by two components. One of these is the change in the market the housing, which the index should reflect, and the other is the change in the structure of the house which should not distort the index.

In brief, the way in which the computations required to calculate the index is modified to take into account this change. If the minimum time period between changes of the index is one day, then on the day (day n) where the sale would normally be added to the index, thereby bringing to light the change in the structure of the house, then that particular house is deleted from the index computation from both that day (day n) and the previous day (day n−1). As a consequence, the change in the index from day n−1 to day n is not distorted by the particular sale with the unknown contribution brought about by the alterations to the house. However, when the index comes to be computed for the next day (day n+1), then the house with the alterations is included on both day n and day n+1 for the calculation of the index for day n+1.

Because the index computation excludes additional capital used in the construction of the housing addition the index, and the portfolio it represents, are said to be self-financing.

First the construction of indices will be discussed and then their “conversion” into self-financing indices.

### Index Construction

In the preferred embodiment residential property indices are calculated, on a daily basis, for the cities of Sydney, Melbourne, Brisbane, Adelaide, Perth, and all of Australia.

For each of the above, there will be 3 indices: (1) houses, (2) units (condominiums or apartments) and all dwellings, and (3) a stock weighted average of the house and unit indices. The dwelling stock figures are from the 2006 Australian census. There is no intention to alter the weights until the 2011 Australian census results are published.

Thus, there will be a total of 18 index series.

The intention of synthetic financial contracts is to represent and mirror as closely as possible returns on the physical asset class (eg monies), but in an idealized market where the asset class is infinitely liquid. An investor would ideally wish to construct a portfolio exactly representing a given market segment. Income from the portfolio would then represent an overall yield from the market segment. The investor would also wish to rebalance their portfolio each period to track changes in market composition.

Thus, returns on the underlying index should equate to returns generated by the above strategy: forming a portfolio, holding it for one period, booking the income yield and capital gain or loss, and then rebalancing the portfolio.

In the case of tradable property indices, there should be capital gain indices and index contracts should pay:

1. The value of the capital gain index at the expiry date.
2. A periodic income equal to a rental yield on the properties composing the index.

Each of the city indices will represent capital value in the sense that
1. They will be based at the mean property value in $000 of the market segment which they represent.
2. Daily returns on each index will equal daily returns on a portfolio of the properties composing the market segment represented.

The All Australia indices will be calculated as a stock weighted average of the corresponding 5 city indices.

Additionally, a daily imputed rental yield will be calculated on each index.

### Calculation of the Indices

### Summary

The indices will firstly represent capital value: daily returns on each index will equal the best estimate of 1 day capital gains on the portfolio of properties represented by the index.

The index calculation is in four parts (see Section 2.2 for details):
1. Value every property in the given category.
2. Form a portfolio of properties which represents the index from the category.
3. Calculate the change in value of that portfolio over the subsequent period ie. 1 business day.
4. Multiply the previous index value by the change in portfolio value.

The calculation to value every property is in six parts:
1. Enter the relevant data adjust (that is, inflate or deflate).
2. Inflate or deflate all observed historical sale prices to a given fixed date via multiplication by the relative hedonic index for the property type (house/unit) and statistical subdivision (SSD) in which the property is located. See Section 2.3 for details of the hedonic index calculation method. Instead of the hedonic index method a median price index can be used instead.
3. Transform the inflated sale price data by a fixed, monotonically increasing function.
4. Fit the transformed data to a set of explanatory variables via a generalized additive model to obtain a valuation function for each property type and SSD.
5. For all properties in the current population, apply the appropriate valuation function to obtain transformed value estimates.
6. Apply the inverse of the transformation function in step 3 to the transformed value estimates in step 4 to obtain the actual property value estimates.

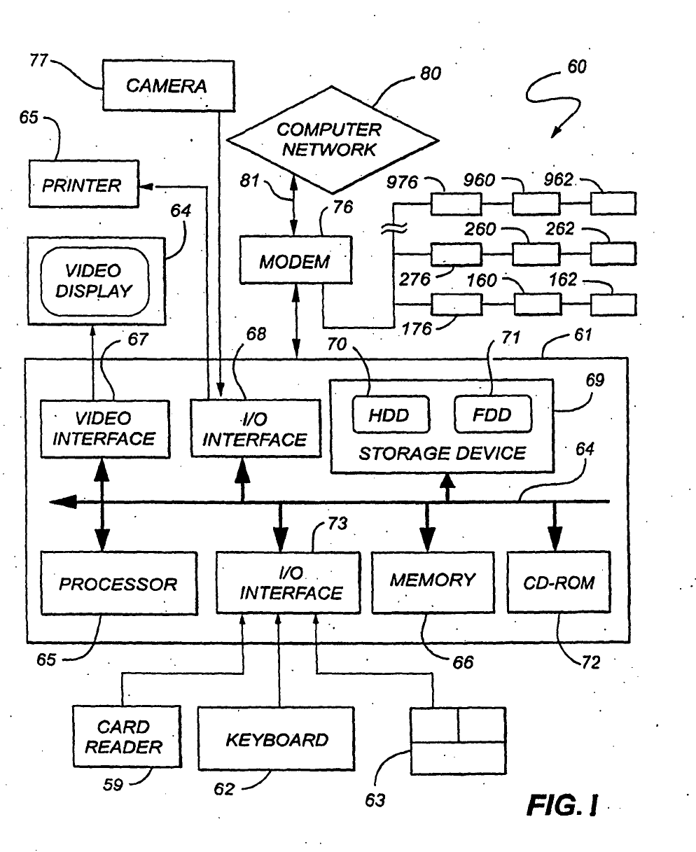

These steps are indicated as steps 1-6 in FIG. 1 of the drawings.

See Section 2.4 for details of steps 2-5 above.

### Section 2.1

### Capital Gain Index Calculation

For each property type (house/unit) and city, the method of calculation is to:

On the initial (base) day t=0:
1. Value every property in the given category, preferably by the hedonic imputation method.
2. Sort the properties by value.
3. Form a “market portfolio” consisting of all properties between the 5^{th} and 95^{th} percentiles. The upper and lower tails are preferably removed for statistical reasons: namely to ensure that the behaviour of outliers does not influence the dynamics of the index away from the dynamics of the actual market. The mean value of this portfolio divided by 1000 is the initial value of the index I₀.
4. Find the total value of all the properties in the market portfolio. Call this value M₀.
On each subsequent day t>0:
1. Value every property in the given category by the hedonic imputation method (see Sections 2.3 and 2.4 below).
2. Find the new total value of all the properties in the previous day's market portfolio. Call this value M.
3. Since the value of Mₜ₋₁ is known from the previous day, the change in value of the portfolio from the previous day is Mₜ*/Mₜ₋₁. The new middle index value is then Iₜ=(Mₜ*/Mₜ₋₁)Iₜ₋₁.
4. Sort all the properties by value.
5. Form a new market portfolio consisting of all properties between the 5^{th} and 95^{th} percentiles after the sort.
6. Calculate the total value of all the properties in the new middle portfolio. Call this value Mₜ.

### Section 2.2

### Hedonic Index Calculation

A hedonic variable is an observable attribute of a good such that variation in the value of the attribute is explanatory of some of the variation in the price of the good. In the case of residential property prices, examples of hedonic attributes are the suburb (location), and land size and the number of bedrooms.

A hedonic property value index is calculated from observed sale prices, taking into account the hedonic attributes of the properties which sold during each observation period. If there is an index series I₀, I₁, . . . , Iₜ, the relative value Iₜ_{₂}/Iₜ_{₁} between any two periods is the least squares error estimate of the mean relative value over the time interval t₁→t₂ of the properties in the population, conditional on observing the prices and hedonic attributes of those properties which actually sold during the period of construction of the index.

Given hedonic variables X₁, . . . , Xₙ, an adjacent period hedonic formula is applied to property sales Pᵢ in each pair of periods (Tₖ₋₁,Tₖ). In our case, each period Tₖ is a calendar month.

$$log {P}_{i} = {c}_{0} ( {T}_{k} ) + {\sum }_{j = 1}^{m} {s}_{j} ( {T}_{k} ) {S}_{j} + {\sum }_{j = 1}^{n} {c}_{j} ( {T}_{k} ) {f}_{j} ( {x}_{j} ) + {λ}_{1} ( {T}_{k} ) {τ}_{1} + {ɛ}_{k} \qquad ( 2.1 )$$

where:
The ƒⱼ are transformations of the hedonic variables.
The cⱼ are time varying numerical coefficients.
The Sⱼ are dummy variables with Sⱼ=1 if property i is in suburb j.
The sⱼ are time varying numerical coefficients of the suburb dummy variables.
τ₁ is a dummy variable with τ₁=1 if the sale occurred in period Tₖ and τ₁=0 otherwise.
εₖ is the (zero mean) residual error term

The above hedonic model thus gives the best estimate of the log return on a property, controlling for its most statistically significant, objectively observable price determining attributes. For further information reference is made to the abovementioned cross-referenced PCT specification.

The coefficient λ₁ gives the hedonic index log returns over the period (Tₖ₋₁, Tₖ). That is, if H(T) is the index value at time T, then

H(Tₖ₋₁)=exp{λ₁(Tₖ)+σ₁(Tₖ)²/2}H(Tₖ₋₂) (2.2)

where σ₁(Tₖ) is the standard error of λ₁(Tₖ). This is preferable adjustment term to make the index track returns on a portfolio.

The hedonic index thus obtained is a capital gain index.

The average return on the hedonic property index over a period [t₀, t] is therefore an estimate of the average return on a diversified property portfolio over [t₀, t].

The price adjustment may also be termed “benchmarking”. The actual imputation index uses an adjacent period index, which is disclosed in Australian Patent Application No. 2008 200 879 (Attorney Ref. 5097′-AU). However, it is possible to use any other different index calculation method to calculate the benchmark index.

There is an additional feature of the use of the benchmark index in the preferred embodiment, whereby a benchmarking index calculated on periods of length T (such as a month) may be adapted as a benchmark for an imputation index with increments over the shorter time interval D (such as a day).

Let n=T/D. Then calculate n benchmarking indices of period T, beginning at the time t=0, D, 2D, . . . , (n−1)D.

For a given time interval τₖ=[kD, (k+1)D], find the n time intervals T₁, . . . , Tₙ of length T in each of the above benchmarking indices which each contain the shorter time interval τₖ.

Take the increments λ₁, . . . λₙ corresponding to the time intervals T₁, . . . , Tₙ from each of the n period T benchmarking indices which contain the shorter time interval τₖ.

The increment Λₖ for period τₖ in the new benchmarking index of period D is the average of the λ₁, . . . , λₙ, that is: Λₖ=(λ₁, . . . , λₙ)/n.

The adapted period D benchmark index value at time t=kD is then either B(t)=B(0)+Λ₁+ . . . +Λₖ or B(t)=B(0)exp{Λ₁+ . . . +Λₖ}, depending on whether or not the original input (sales price) data was transformed prior to calculation of the benchmarking indices.

The transformations ƒⱼ are determined in the following manner:

Let input variable 1 be the land size, with c₁ its coefficient and ƒ₁ its transformation.

The objective function

$$log {P}_{i} = {c}_{0} ( {T}_{k} ) + {\sum }_{j = 1}^{m} {s}_{j} ( {T}_{k} ) {S}_{j} + {c}_{1} ( {T}_{k} ) {f}_{1} ( {x}_{1} ) + {λ}_{1} ( {T}_{k} ) {τ}_{1} + {ɛ}_{k} \qquad ( 2.3 )$$

is used to begin.

That is, only the landsize and suburb are regressed against the log of observed price. Various functional forms of ƒ₁ have been tested, with the best ie. the one which minimises the standard deviation of the error εₖ found to be ƒ₁(x)=log x.

For each of the input variables i with a non-binary domain, let the range of observable values bε_{i,1}, . . . , x_{i,n}_{ᵢ}. For j=1, . . . , nᵢ, let χ_{i,j} be a dummy variable with χ_{i,j}=1 if Xᵢ=x_{i,j}.

For each i>1, determine the coefficients γ_{i,j} in the regression:

$$log {P}_{i} = {c}_{0} ( {T}_{k} ) + {\sum }_{j = 1}^{m} {s}_{j} ( {T}_{k} ) {S}_{j} + {c}_{1} ( {T}_{k} ) {f}_{1} ( {x}_{1} ) + {\sum }_{j = 1}^{{n}_{i}} {γ}_{i , j} ( {T}_{k} ) {χ}_{i , j} + {λ}_{1} ( {T}_{k} ) {τ}_{1} + {ɛ}_{k} \qquad ( 2.4 )$$

Each transformation function ƒᵢ, i>1 is then completely defined by ƒᵢ(x_{i,j})=γ_{i,j}.

Thus, each transformation ƒᵢ, i>1 is determined by regressing suburb and log (landsize) with dummy variables describing the possible values of the input Xᵢ against log of observed price, one input variable Xᵢ at a time.

The set of objectively observable attributes X₁ . . . , Xₙ in the hedonic index preferably are:
Suburb
Landsize (m²) if property type=house
Floorsize (m²) if property type=unit
Street type eg. highway, main road, suburban street, cul de sac etc.
Property type eg. free standing house, semi-detached house, low rise apartment, high rise apartment
Construction type eg. brick, timber, weatherboard
Number of bedrooms
Number of bathrooms
Ratio of bedrooms/bathrooms
Number of carspaces
Pool (Y/N)
Waterfront (Y/N)
Air Conditioning (Y/N)
View (Y/N)

### Section 2.3

### Valuation of Individual Properties

As discussed in Section 2.1, the valuation of each property in the population is a 5 step process. It will be recalled that a different model is preferably fit for each property type (house/unit) and each statistical sub-division or SSD (same general mathematical structure for all models, but different parameter values).

Thus in what follows, it is assumed that all properties are of the same type (house/unit) and in the same SSD (although any geographical region or market segment can be used, for example a local government area, a suburb or houses above, say, $2 million in price):

Each observed property sale at price Pᵢ and time Tᵢ will have hedonic attribute values {tilde under (x)}ᵢ where {tilde under (x)} is an evaluation of {tilde under (X)}=(Xᵢ, . . . , Xₙ). Note that some elements of {tilde under (x)}ᵢ may be NULL if there is missing data, for example if the number of bathrooms is not known.

Suppose the current time is Tₜ.
1. Adjust (ie. inflate or deflate) all observed sale values by the relative hedonic index value:

\tilde{P}ᵢ=(Iₜ/Iᵢ)Pᵢ (2.5)
2. Transform the inflated sale prices by a suitable continuous, monotonically increasing function:

Yᵢ=Φ(\tilde{P}ᵢ) (2.6)
3. Fit a generalized, additive model (GAM) Ψ: (X₁, . . . , Xₙ) [symbol] Y which maps observed hedonic attribute data to the transformed prices.

The set of hedonic observables in the GAM are those in the hedonic index plus:
Month of observed sale
Most recent previous sale of the property, adjusted (typically inflated) by the relative hedonic index
Sales of nearest neighbours, adjusted (inflated or deflated) by the relative hedonic index
Latitude and longitude of property

Nearest neighbours are taken to be those properties closest in distance with the same number of bedrooms. If the number of bedrooms in the observed sale property is not known, the nearest neighbours are just those closest in distance, ignoring the number of bedrooms.

Separate models are used for properties with an unknown number of bedrooms, unknown number of bathrooms or missing values for other attributes.

Note that not all properties have records of previous sales, so this hedonic variable can be NULL.

Conceptually, the GAM is then:

$${\hat{Y}}_{i}^{0} = {c}_{0} + {\sum }_{j = 1}^{m} {\sum }_{k = 1}^{n} {c}_{jk} {S}_{j} {f}_{k} ( {x}_{k} ) + {ɛ}_{i}^{0} \qquad ( 2.7 )$$

where:
The ƒₖ are transformations of the hedonic variables.
The cⱼₖ are numerical coefficients.
The Sⱼ are dummy variables with Sⱼ=1 if property i is in suburb j.
εᵢ⁰=Yᵢ−Ŷᵢ⁰ is the (zero mean) residual error term

The residuals εᵢ⁰ are then fit by least squares to a 2-D cubic spline function of the latitude and longitude (uᵢ, vᵢ):

εᵢ⁰=g(uᵢ,vᵢ)+εᵢ (2.8)

The final model is then

$${\hat{Y}}_{i} = {c}_{0} + {\sum }_{j = 1}^{m} {\sum }_{k = 1}^{n} {c}_{jk} {S}_{j} {f}_{k} ( {x}_{k} ) + g ( {u}_{i} , {v}_{i} ) + {ɛ}_{i} \qquad ( 2.9 )$$

4. Given a particular property with observed hedonic attributes (x₁, . . . , xₙ, u, v), obtain the transformed price estimate from the GAM:

Ŷ=Ψ(x₁, . . . ,xₙ,u,v) (2.10)
5. The GAM price estimate is then

\hat{P}=Φ⁻¹(Ŷ) (2.11)

Steps 4 and 5 above are applied to all properties in the relevant population to obtain the list of values in Step 1 of Section 2.2.

### Section 2.4

### Calculation of Rental Yields Introduction

Rental yields are calculated daily. The yield is intended to represent the rental income for the given day as a proportion of total property market value if all properties in the population were rented without any market dilution effects.

Clearly only a minority of properties are actually rented at any given time and the majority of those were rented during a prior period.

The figures in the following Table I are from the 2006 Australian Census:

Table I

| | | | |
|---|---|---|---|
| City | % Owned | % Mortgaged | % Rented |

Houses

| | | | |
|---|---|---|---|
| Sydney | 40.2% | 41.0% | 18.8% |
| Melbourne | 40.4% | 42.4% | 17.2% |
| Brisbane | 34.0% | 42.4% | 23.6% |
| Adelaide | 39.9% | 42.7% | 17.4% |
| Perth | 34.6% | 45.0% | 20.4% |

Units

| | | | |
|---|---|---|---|
| Sydney | 18.1% | 21.8% | 60.1% |
| Melbourne | 18.6% | 19.0% | 62.4% |
| Brisbane | 15.3% | 16.3% | 68.4% |
| Adelaide | 21.1% | 17.9% | 60.9% |
| Perth | 20.2% | 20.5% | 59.4% |

Consequently, a hedonic rental formula, essentially a “rental automatic valuation method” is derived from observed rents and the attributes of the properties which do rent. This formula is then applied to impute rental income for those properties not being rented (because they are owner occupied).

The rental yield for each index is the sum of the imputed rental incomes for every property in the population divided by the sum of the imputed property values derived by the method of Section 2.3. The rental income for each index linked note is then that day's rental yield multiplied by the day's index value.

### Rental Yield Calculation

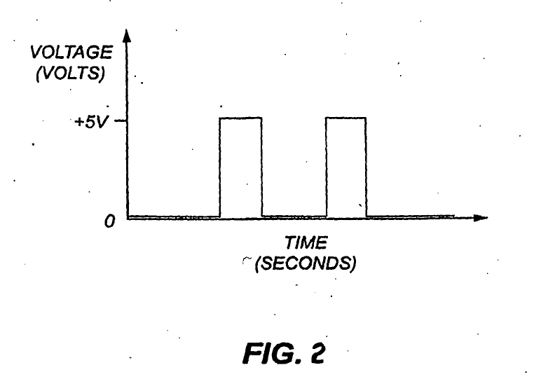

The method of imputing rents for all properties in the population is first described with reference to steps 15-20 of FIG. 2.

As with valuation of all properties in Section 2.2, a different rental model is fit for each property type (house/unit) and each SSD (same general mathematical structure for all models, but different parameter values). Thus in what follows, it is assumed all properties are of the same type (house/unit) and in the same SSD.

All rental listings (most recent listing price) occurring in the 6 months prior to the calculation date are used. The reason for the 6 months time period is that properties advertised for rent during this time period can reasonably be assumed to be currently rented at the same rate. The most recently advertised rent is used where confirmation of the actual rent is not available, which is usually the case. All rents are converted to an annual figure, counting 365 days in a year.

Suppose there are N properties in the population, for which we have value estimates \hat{P}₁, . . . , P_{N}, by the method of Section 2.3. Suppose we have observed rental information R₁, . . . , R_{M} for M<N of these properties.

We use the same hedonic variables listed in Section 2.3 and the method of Section 2.4 to fit a hedonic imputation model for the rental income from any property, given its hedonic attributes (without needing to inflate or deflate the rents as in step 2 of FIG. 1):

\hat{R}=Φᵣₑₙₜ⁻¹(Ψᵣₑₙₜ(x₁, . . . ,xₙ)) (3.1)

where (x₁ . . . , xₙ) is the vector of observed hedonic attributes.

We thus obtain a full set of N rental estimates \hat{R}₁, . . . , \hat{R}_{N} for all properties in the population.

The annualized yield for the given day is then

$${y}_{t} = {\sum }_{i = 1}^{N} {\hat{R}}_{i} / {\sum }_{i = 1}^{N} {\hat{P}}_{i} \qquad ( 3.2 )$$

The day's rental income per index is then

rent=yₜIₜ/365 (3.3)

where Iₜ is that day's index value.

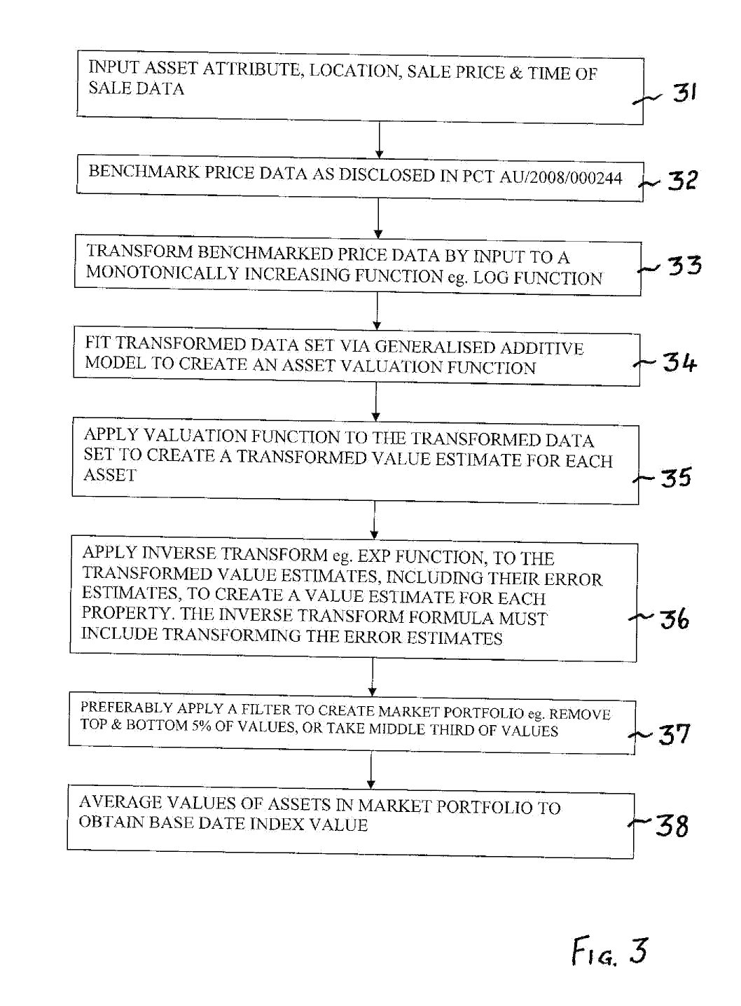

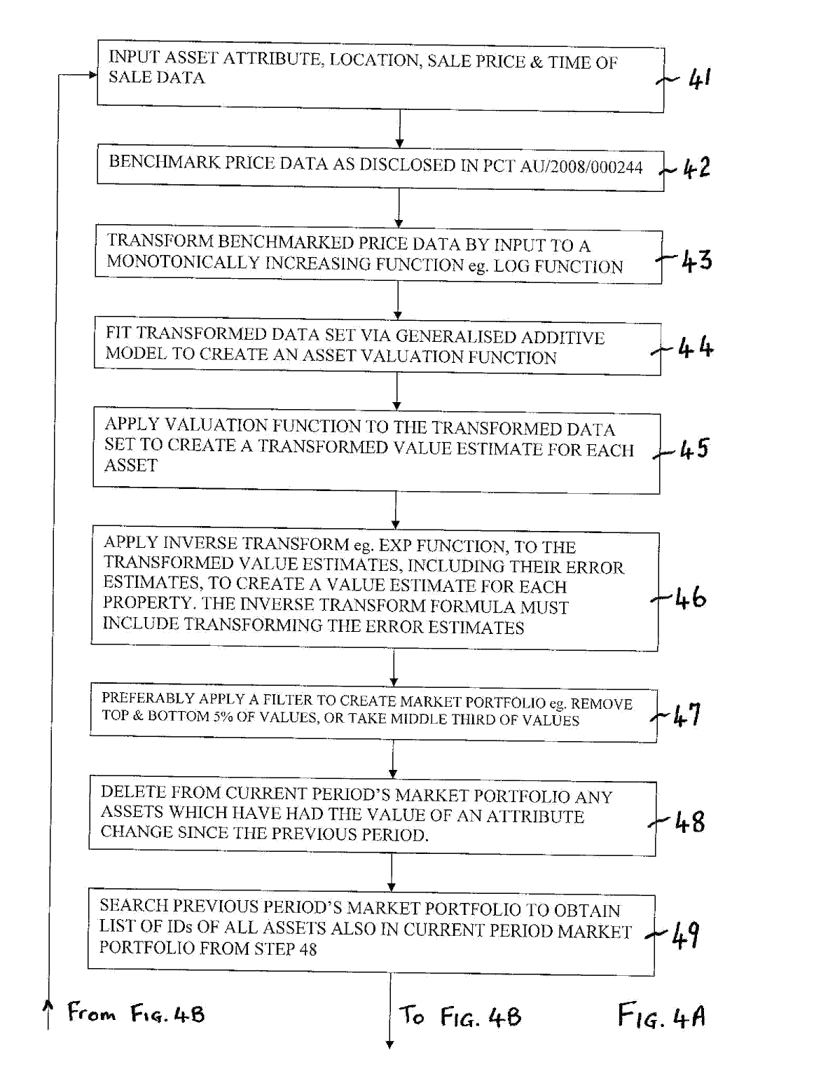

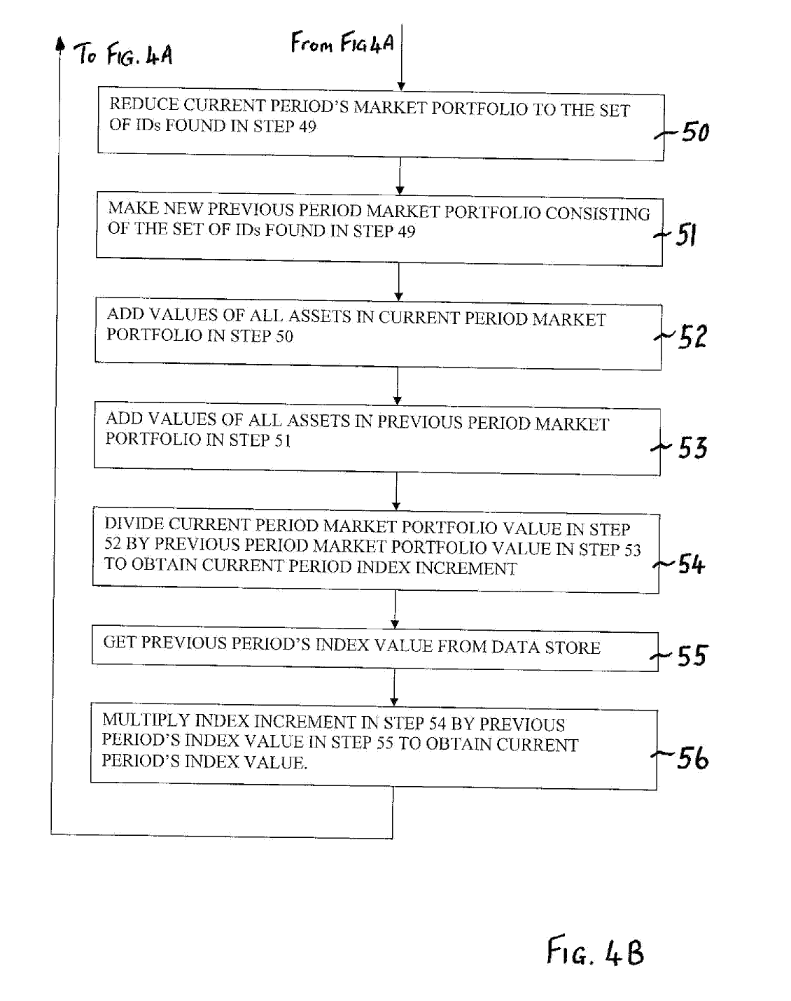

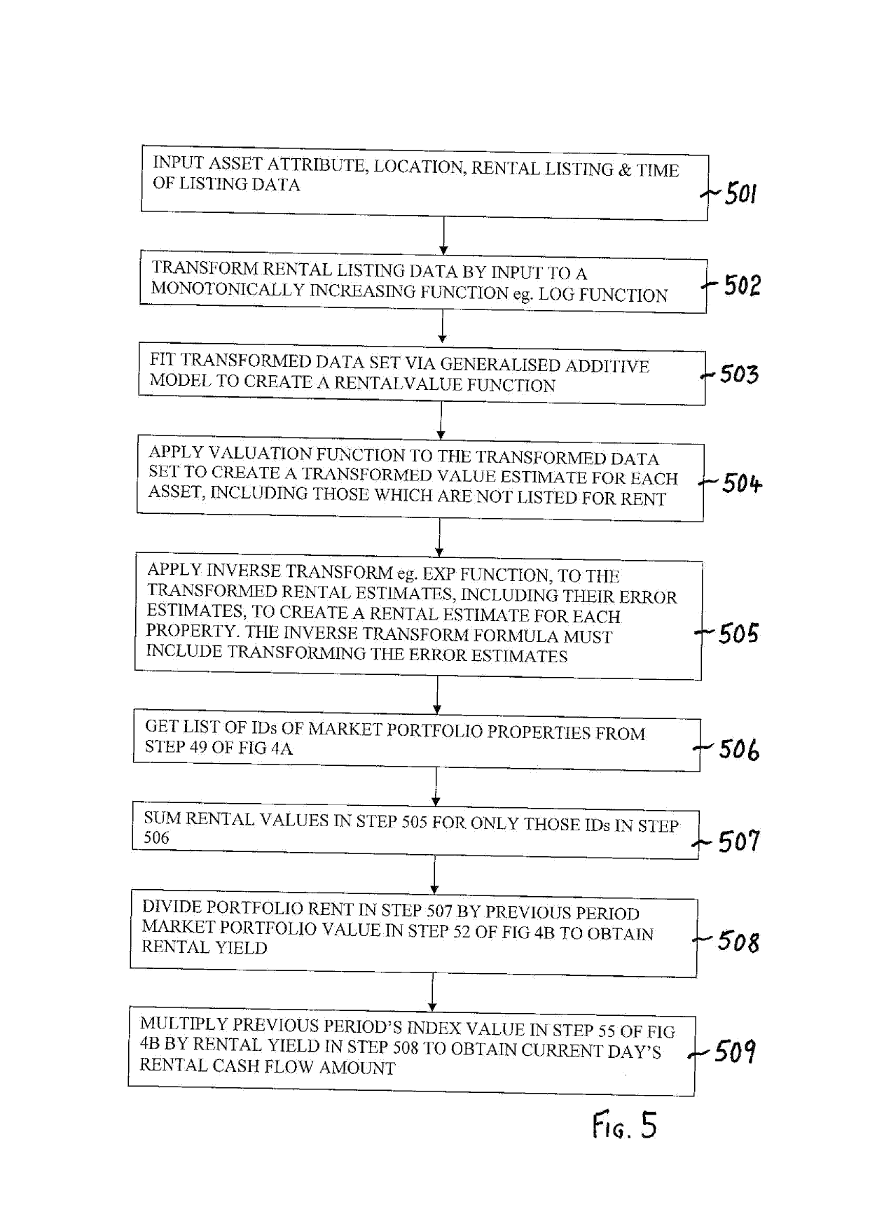

Turning now to FIGS. 3-5, in FIG. 3 the steps 31-38 required for the calculation of the asset index for a base date are set out. These mirror steps 1-9 of FIG. 1. At a subsequent date, the index is calculated carrying out the steps 41-56 as set out in FIGS. 4A-4B which flow over two sheets. Steps 41-47 of FIG. 4A mirror steps 31-37 of FIG. 3, however, in steps 48-51 the current period's market portfolio is amended by deleting any assets which have had a value of an attribute change since the previous period. Thus a house which has had a bedroom added had since it was last sold, will be deleted from the market portfolio. Thereafter, steps 52-56 are carried out using the adjusted portfolio to obtain the current period's index value.

On the next occasion on which the index value is calculated, normally the next day but conceivably the next week or month, steps 41 to 56 are repeated. However, on this occasion the specific assets which have had an attribute change in the previous period will not have had that same, or any, attribute change in the current period. Therefore those assets which were excluded on the previous occasion, will be included on the next occasion.

In order to produce an accumulation index including rental income, the steps 501-509 of FIG. 5 are carried out. These steps mirror the steps 15-22 of FIG. 2 save that again the asset or property portfolio excludes those assets in which an attribute changed. This exclusion arises easily because the work carried out in previous steps 48 and 49 of FIG. 4A is effectively repeated in step 507.

### ANNEXURES

Annexure 1 is a paper entitled “Validation of ASX Property Indices” which provides an estimate of the accuracy of daily indices with monthly indices used hitherto, and Annexure 2 is a paper entitled “Calculating High Frequency Australian Residential Property Price Indices” which explains the temporary dropping or removal of a property from the index where there is a value change of the nature of a capital inflow (eg an additional bedroom) or of the nature of a capital outflow (eg a lessening of the land size as a result of a sub-division) so that the index is correctly self-financing.

### INDUSTRIAL APPLICATION

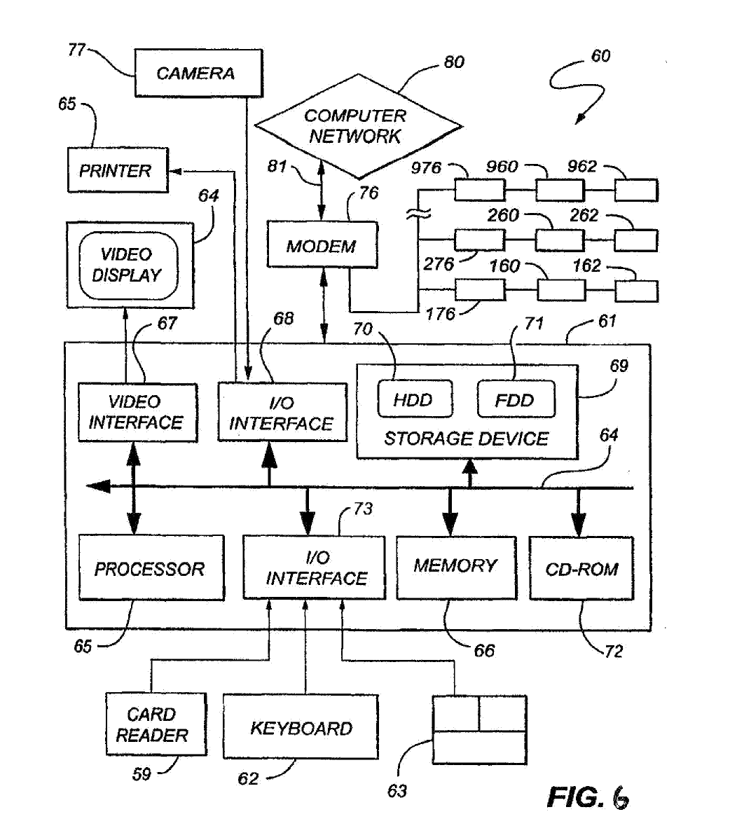

The methods and processes described above are preferably practised using a conventional general-purpose computer system 60, such as that shown FIG. 6 wherein the processes are implemented as software, such as an application program executed within the computer system 60. In particular, the steps of the processes are effected by instructions in the software that are carried out by the computer. The software can be divided into two separate parts; one part for carrying out the specific processes; and another part to manage the user interface between the latter and the user. The software is able to be stored in a computer readable medium, including the storage devices described below, for example. The software is loaded into the computer from the computer readable medium, and then executed by the computer. A computer readable medium having such software or computer program recorded on it is a computer program product. The use of the computer program product in the computer results in an advantageous apparatus for carrying out embodiments of the invention.

The computer system 60 comprises a computer module 61, input devices such as a keyboard 62 and mouse 63, output devices including a printer 65 and a display device 64. A Modulator-Demodulator (Modem) transceiver 76 is used by the computer module 61 for communicating to and from a communications network 80, for example connectable via a telephone line 81 or other functional medium. The modem 76 can be used to obtain access to the Internet, and other network systems, such as a Local Area Network (LAN) or a Wide Area Network (WAN) or other computers 160, 260, . . . 960, etc each with their own corresponding modem 176, 276, . . . 976, etc and each having a data input terminal 162, 262, . . . 962, etc. Each of the computers 160-960 are used to collect data for the preparation of an index, for example.

The computer module 61 typically includes at least one processor unit 65, a memory unit 66, for example formed from semiconductor random access memory (RAM) and read only memory (ROM). There are input/output (I/O) interfaces including a video interface 67, and an I/O interface 73 for the keyboard 62, mouse 63 and optionally a card reader 59, and a further interface 68 for the printer 65 or optionally a camera 77. A storage device 69 is provided and typically includes a hard disk drive 70 and a floppy disk drive 71. A magnetic tape drive (not illustrated) can also be used. A CD-ROM drive 72 is typically provided as a non-volatile source of data. The components 65 to 73 of the computer module 61, typically communicate via an interconnected bus 64 and in a manner which results in a conventional mode of operation of the computer system 60 known to those in the relevant art. Examples of computers on which the embodiments can be practiced include IBM-PC's and compatibles, Sun Sparcstations or alike computer systems evolved therefrom.

Typically, the application program of the preferred embodiment is resident on the hard disk drive 70 and read and controlled in its execution by the processor 65. Intermediate storage of the program and any data from the network 80 is accomplished using the semiconductor memory 66, possibly in concert with the hard disk drive 70. In some instances, the application program is encoded on a CD-ROM or floppy disk and read via the corresponding drive 72 or 71, or alternatively is read from the network 80 via the modem device 76. Still further, the software can also be loaded into the computer system 60 from other computer readable media including magnetic tape, a ROM or integrated circuit, a magneto-optical disk, a radio or infra-red transmission channel between the computer module 61 and another device, a computer readable card such as a PCMCIA card, and the Internet and Intranets including email transmissions and information recorded on websites and the like. The foregoing is merely exemplary of relevant computer readable media. Other computer readable media may be practiced without departing from the scope and spirit of the invention.

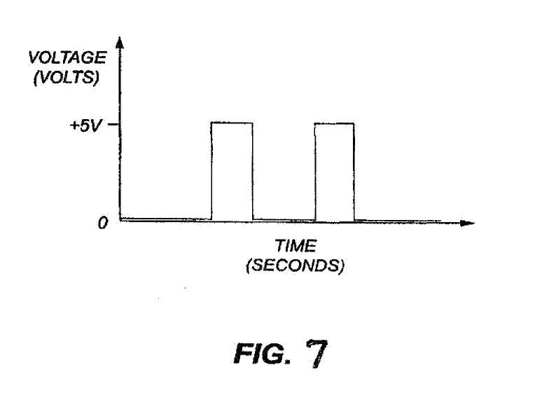

It should not be lost sight of that the purpose of the computer system 60 is to generate a digitally encoded electric signal (such as that illustrated in FIG. 7) which when applied to an output interface (such as the display device 64 or the printer 65) produces an indicium or indicia which convey information and which are legible or intelligible to a human. For example, the electric signal illustrated in FIG. 7 is a binary encoded signal 00101 which when applied to the display device 64 or printer 65 causes the indicium 9 to be displayed or printed.

The processes can alternatively be implemented in dedicated hardware such as one or more integrated circuits performing the functions or sub functions of the processes. Such dedicated hardware can include graphic processors, digital signal processors, or one or more microprocessors and associated memories.

The foregoing describes only some embodiments of the present invention and modifications, obvious to those skilled in the financial and computing arts, can be made thereto without departing from the scope of the present invention.

The term “comprising” (and its grammatical variations) as used herein is used in the inclusive sense of “including” or “having” and not in the exclusive sense of “consisting only of”.

1. A method of calculating an index of price movements of a class of assets, which index is substantially independent of price movements of a capital nature, said method comprising the steps of:
(i) storing historical time of sale data, historical price data and historical asset characterisation data regarding previous asset sales of assets in said class of assets,
(ii) inputting a tranche of current data regarding current sales of assets in said class of assets, said current data including current price data and current asset characterisation data,
(iii) comparing said current asset characterisation data with said historical asset characterisation data to identify specific assets which have been sold previously and re-sold currently,
(iv) comparing the asset characterisation data of said specific assets to determine those specific assets, if any, which have undergone a change of a capital nature between said previous sale and said current re-sale, and
(v) excluding said capital change specific assets from said index generation.

2. The method as claimed in claim 1 wherein said index is calculated on each occasion of a successive sequence of occasions, and said excluding step (v) comprises:
(vi) excluding the capital change specific assets from a portfolio assets used in the current index calculation to calculate a current portfolio value,
(vii) re-calculating the value of the same portfolio of assets on the occasion immediately preceding the current occasion,
(viii) summing the current portfolio values, summing the immediately preceding portfolio values and dividing the sum of the current portfolio values by the sum of the immediately preceding portfolio values to create the index increment for the current index calculation.

3. The method as claimed in claim 2 wherein to calculate the immediately next succeeding index said portfolios of assets include said capital change specific assets.

4. The method as claimed in claim 3 wherein said index is a capital gain index.

5. The method as claimed in claim 3 wherein said index is an accumulation index.

6. The method as claimed in claim 5 wherein said index relates to real estate property and said accumulation index includes rental income.

7. A method of generating a digitally encoded electric signal to represent an index of price movements of a class of assets, which index is substantially independent of price movements of a capital nature, said method comprising the steps of:
(i) storing in a data storage means historical time of sale data, historical price data and historical asset characterisation data regarding previous asset sales of assets in said class of assets,
(ii) inputting into said data storage means a tranche of current data regarding current sales of assets in said class of assets, said current data including current price data and current asset characterisation data,
(iii) comparing, in a comparator means connected with said data storage means, said current asset characterisation data with said historical asset characterisation data to identify specific assets which have been sold previously and re-sold currently,
(iv) comparing in said comparator means the asset characterisation data of said specific assets to determine those specific assets, if any, which have undergone a change of a capital nature between said previous sale and said current re-sale,
(v) computing said index whilst excluding said capital change specific assets from said computation, and
(vi) outputting said digitally encoded electric signal to represent said index.

8. The method as claimed in claim 7 wherein said index is calculated on each occasion of a successive sequence of occasions, and said excluding step (v) comprises:
(vi) excluding the capital change specific assets from a portfolio assets used in the current index calculation to calculate a current portfolio value,
(vii) re-calculating the value of the same portfolio of assets on the occasion immediately preceding the current occasion,
(viii) summing the current portfolio values, summing the immediately preceding portfolio values and dividing the sum of the current portfolio values by the sum of the immediately preceding portfolio values to create the index increment for the current index calculation.

9. The method as claimed in claim 8 wherein to calculate the immediately next succeeding index said portfolios of assets include said capital change specific assets.

10. The method as claimed in claim 9 wherein said index is a capital gain index.

11. The method as claimed in claim 9 wherein said index is an accumulation index.

12. The method as claimed in claim 11 wherein said index relates to real estate property and said accumulation index includes rental income.
